(19) United States
(12) Patent Application Publication
(10) Pub. No.: US 2011/0132144 A1
(43) Pub. Date: Jun. 9, 2011

(54) Method For Producing Metal Nanoparticles In Polyols

(76) Inventors: Jochen Mezger, Garching an der Alz (DE); Laurent Marc, Hericy (FR); Simone Klapdohr, Rosenheim (DE); Burkhard Walther, Garching (DE); Zhizhong Cai, Trostberg (DE); Tobias Austermann, Munster (DE); Silke Flakus, Ebersberg (DE); Helmut Mack, Traunstein (DE)

(21) Appl. No.: 13/003,785

(22) PCT Filed: Jul. 15, 2009
(86) PCT No.: PCT/EP2009/059088

§ 371 Date: Feb. 18, 2011

(30) Foreign Application Priority Data
Jul. 23, 2008 (EP) 08161011.5

(51) Int. Cl. B22F 9/18; B22F 9/00; B82Y 40/00

(52) U.S. Cl. 75/345; 75/343; 977/895

(57) ABSTRACT

The invention relates to a process for the preparation of metal nanoparticles, selected from the group consisting of lead, bismuth, zinc, antimony, indium, gold, nickel, cobalt, palladium, platinum, iridium, osmium, rhodium, ruthenium, rhenium, vanadium, chromium, manganese, niobium, molybdenum, tungsten, tantalum, cadmium, silver and/or copper, on a rotating body, characterized in that a reduction of corresponding metal salts, corresponding metal salt complexes, corresponding metal hydroxides and/or corresponding metal oxides by polyols having a number of hydroxyl groups in the polyol of 1 to 10 and a molecular weight of the polyols of 2000 to 18 000 Da is effected.

The present invention relates to a process for the preparation of metal nanoparticles. It is preferably a process for the preparation of polyol- and metal nanoparticle-containing (intermediate) products which are directly suitable for further processing in polyurethane products, in particular in polyurethane-based sealants and adhesives.

The demand in industry for regularly shaped nanoparticles having a narrow size distribution has greatly increased. Important fields of use are, for example, conductive inks or sealants and adhesives for the production of various electronic components. For example, WO2007/004767 describes silicone-based sealing compounds which contain silver nanoparticles as an antibacterial and fungicidal additive.

The preparation of metal particles by the so-called “polyol process” was first described by Figlarz et al. in U.S. Pat. No. 4,539,041 A1. There, a metal compound is reduced by a polyol at a relatively high temperature. The metal particles thus obtained have a size in the micron or nanometre range. In a modification of this method, the process is carried out in the presence of a polymer, such as, for example, polyvinylpyrrolidone, at room temperature [P.-Y. Silvert et al., J. Mater. Chem. 1996, 6(4), 573-577; J. Mater. Chem. 1997, 7(2), 293-299].

In a further variant, which is described in WO 2006/076612 A2, the reduction takes place in the presence of a compound which can be adsorbed onto the nanoparticles and thus reduces the agglomeration of the particles.

Silver nanoparticles can also be produced in polyethylene glycol (400 Da) by reduction with hydrogen gas at room temperature [Wenjin Yan, Rui Wang, Zhaoqing Xu, Jiangke Xu, Li Lin, Zhiqiang Shen, Yieng Zhou, Journal of Molecular Catalysis A. Chemical 2006, 255, 81-85].

A more recent paper describes the preparation of silver particles in a continuous process by means of a spinning disc reactor [K. Swaminathan Iyer, Colin L. Raston and Martin Saunders, Lab on a Chip 2007, 7(12), 1800-1805]. There, silver nitrate is reduced in the matrix of soluble starch, polyvinylpyrrolidone and polyethylene glycol 400 by ascorbic acid (Vitamin C).

Metal nanoparticles as an antibacterial and fungicidal additive are also important in the polyurethane industry and in particular in the field of polyurethane-based sealants and adhesives. In industry generally and particularly in said areas of work, processes are desired which can be realized in a simple and rational manner (few process steps) and with the use of as few raw materials as possible and with avoidance of waste products. Furthermore, additives which are “foreign to polyurethane” and which may change the properties of the polyurethane products in a disadvantageous manner should be present in as small an amount as possible.

In the processes mentioned in the prior art, low molecular weight polyols are used. This is associated with the use of further auxiliary reagents, such as, for example, This is associated with the use of further auxiliary reagents, such as, for example, ascorbic acid as a reducing agent (for increasing the yield) or stabilizers (mainly for achieving small particle sizes), such as, for example, starch, polyvinylpyrrolidone or polyvinylpyridine. The use of these substances not desired in polyurethane products adversely affects the properties of polyurethane products, in particular of polyurethane-based sealants and adhesives. For example, migration of the additives (also oligomeric additives) may occur, which is undesired in sealants and adhesives. Polyvinylpyrrolidone is readily soluble in water and is hygroscopic which is not desired in sealants. Owing to its hydrophilic properties, polyvinylpyrrolidone retains or attracts water. The presence of water is very troublesome in the further processing of the polyols with isocyanates to give polyurethane products, owing to relevant secondary reactions. Polyvinylpyridine can also lead to undesired reactions with Lewis acid catalysts from the polyurethane synthesis. Hydroxy-functional compounds, such as ascorbic acid and starch, are reactive towards isocyanate groups, resulting in undesired secondary reactions with isocyanates. Substances such as, for example, starch or polyvinylpyrrolidone tend to form hydrogen bridges. The formation of hydrogen bridges in PU prepolymers intended, for example, for further processing to sealant systems generally leads to an increase in the viscosity, which has a disadvantageous effect on the further processing (formulation). This should as far as possible be avoided in adhesives and sealants.

Water is frequently present in polyurethane raw materials, in particular the polyols, and often presents a problem owing to relevant secondary reactions with the isocyanate function. It would be desirable to provide a process which could also solve this problem in a single operation in an economical manner.

The processes mentioned in the prior art are therefore not very suitable for the preparation of polyol- and metal nanoparticle-containing (intermediate) products which are directly suitable for further processing in polyurethane products, in particular in polyurethane-based sealants and adhesives. Furthermore, in the preparation of metal nanoparticles by the processes mentioned in the prior art, the problem arises that “caking” of metal particles can occur and particles which are not sufficiently small are obtained. The consequence of this is that the yield of metal nanoparticles in the desired size range is low and the particle size distribution is relatively broad.

An object of the present invention is therefore to provide a process for the preparation of metal nanoparticles which avoids the abovementioned disadvantages of the prior art, in particular the caking of the metal particles. Furthermore, a high yield of metal nanoparticles should be achieved.

The metal nanoparticles should preferably be prepared in a medium which permits the preparation of the metal nanoparticles with the abovementioned desired properties (particle size) and the product thus obtained should be suitable for direct further processing to give products based on polyurethane, in particular polyurethane-based sealants and adhesives. The metal nanoparticles should furthermore be capable of being further processed in as economical a manner as possible (for example saving of solvents) and without any further process steps (for example no isolation steps or purification steps, such as separating off solvent(s) or stabilizers) for use in sealants based on polyurethane.

The abovementioned objects were achieved by the process according to the invention for the preferably continuous preparation of metal nanoparticles, preferably of metal nanoparticles selected from the group consisting of lead, bismuth, zinc, antimony, indium, gold, nickel, cobalt, palladium, platinum, iridium, osmium, rhodium, ruthenium, rhenium, vanadium, chromium, manganese, niobium, molybdenum, tungsten, tantalum, cadmium, silver and/or copper, preferably nickel, platinum, ruthenium, cobalt, iridium and/or gold, particularly preferably silver and/or copper, on a rotating body, preferably a rotating reactor disc, which is particularly preferably a ceramic disc or a metal disc, characterized in that a reduction of corresponding metal salts, preferably of formates, trifluoroacetates, propionates, oxalates, tartrates, malates and/or citrates, particularly preferably of nickel/tetramine and/or silver/diamene complexes, particularly preferably of nitrates and acetates, of corresponding metal hydroxides, preferably of nickel hydroxide, cobalt hydroxide and/or copper hydroxide, and/or corresponding metal oxides, preferably of nickel oxide, silver oxide, cobalt oxide and/or copper oxide, by polyols having a number of hydroxyl groups in the polyol of 1 to 10, preferably of 2 to 6, hydroxyl groups and a molecular weight of the polyols of 2000 to 18 000 Da, preferably of 3000 to 12 000 Da is effected. Zinc is the least preferred in the above list of the metals. The process according to the invention is preferably a process for the preparation of polyol- and metal nanoparticle-containing (intermediate) products which are directly suitable for further processing polyurethane products, in particular in polyurethane-based sealants and adhesives. The process should preferably be capable of being operated without addition of starch and/or polyvinylpyrrolidone, particularly preferably without addition of reducing agents, such as, for example, ascorbic acid. Very particularly preferably, the process can be operated without polymeric, oligomeric or other additives.

The process according to the invention is based on the technology known as a spinning-disc reactor (SDR). This is pertinently known in the technical literature and is described, for example, in WO 2003/008083. The SDR process is particularly preferably operated continuously with feeding of a starting material solution onto a rotating reactor disc. The product obtained after the reaction on the disc is usually removed and collected. The reactor disc may consist of any material suitable in the temperature ranges used. Ceramic discs are preferred and metal discs are even more preferred. A disc comprising copper coated with a covering of chromium is particularly preferred.

The rotating body on which chemical reactions can be carried out may have various shapes, for example, disc-shaped, vase-shaped, annular or conical. A circular reactor disc is preferred. The surface of such reactor discs may be modified by ripple-like or spiral mouldings, with the result that the average residence time can be influenced. Reactor discs having a smooth surface are preferred.

It is also possible to carry out the chemical reaction on two rotating bodies (or rotating discs) arranged in series. For this purpose, the product solution emerging from the first SDR reactor after application to a first rotating surface is applied to the second rotating body. It is also possible, in an analogous manner, to use more than two reactor discs. It is also possible to carry out a circulation process with one reactor by collecting the product solution obtained from the rotating body and applying it again to said rotating body. An advantage of this procedure is that the conversion (yield of metal nanoparticles) can be increased.

The rotational speed of the rotating body is usually 1 to 20 000 revolutions per minute, preferably 100 to 5000 and particularly preferably 200 to 3000, revolutions per minute.

The average residence time (frequency average of the residence spectrum) of the mixture is dependent on a few factors, such as, for example, the type of reaction substrate (in particular its viscosity), the temperature on the surface of the reactor disc and particularly the rotation rate. Usually, it is between 0.01 and 60 seconds, particularly preferably between 0.1 and 10 seconds. These relatively short residence times are particularly advantageous in the chosen process since the decomposition of sensitive products, such as, for example, some polyesterpolyols, can be substantially avoided thereby.

On application to the rotating body, the reaction substrate preferably forms a film which has an average thickness of 0.1 μm to 6.0 mm, preferably of 60 to 1000 μm, particularly preferably of 100 to 500 μm.

Metal nanoparticles are to be understood as meaning particle sizes up to 200 nm, preferably from 50 to 100 nm and particularly preferably particle sizes from 20 to 50 nm, preferably determined by transmission electron microscopy (TEM). The aim is to obtain nanoparticles which are as small as possible.

Metal salts of organic and/or inorganic acids, such as, for example, nitrates, nitrites, sulphates, halides, carbonates, phosphates, borates, tetrafluoroborates, sulphonates, carboxylates (such as, for example, formates, acetates, propionates, oxalates) and/or substituted carboxylates, such as, for example, halocarboxylates (e.g. trifluoroacetates), hydroxycarboxylates (e.g. tartrates, malates and/or citrates) and/or aminocarboxylates are preferably used as metal compounds suitable for the reduction. Furthermore, it is possible to use salts and acids in which the metal is part of the anion, such as, for example, hexachloroplatinates, hexafluoroplatinates and/or tetrachloroaurates. Copper(II) acetate, copper(II) nitrate, copper(II) sulphate, copper (II) chloride, copper(II) formate, silver nitrate, silver acetate, silver formate, silver tetrafluoroborate, silver nitrite, silver carbonate, silver oxalate, silver propionate, silver fluoride, nickel chloride, nickel nitrate, nickel sulphate, nickel tetrafluoroborate and/or nickel oxalate may preferably be mentioned as suitable metal salts. Here, metal salts are understood as meaning metal salts which are not oxides and/or hydroxides.

Metal salts are also to be understood as meaning metal salt complexes. For example, these may be complex compounds of the corresponding metals with preferably nitrogen-containing ligands, such as, for example, ammonia, ethylenediamine, diethylenediamine, propylenediamine, aminoalcohols, such as, for example, ethanolamine, amino acids, such as, for example, glycine, amides, such as, for example, formamide, acetamide and/or benzamide. Complex compounds with heterocyclic compounds, such as, for example, 2,2′-bipyridine, 4,4′-dialkyl-2,2′-bipyridine, pentamethyldiethylenetriamine (PMDETA), o-phenanthroline, tris(2-dimethylaminoethyl)amine, TPEN (N,N,N′,N′-tetrakis(2-pyridinylmethyl)-1,2-ethanediamine, pyrroles, aziridines, indoles, piperidines, morpholines, pyridines, imidazoles, piperazines and/or triazoles, can also be used.

Other suitable complex salt formers are, for example, beta-diketonates (e.g. acetylacetonate), thiosulphates and/or cyanides.

Metal salt alkoxides, such as metal salts of branched or straight-chain C-1 to C-5 alcohols, are likewise suitable for carrying out the invention. Copper methanolate, copper ethanolate and/or nickel isopropanolate may be mentioned by way of example.

Metal hydroxides are also suitable in the process according to the invention, nickel hydroxide, cobalt hydroxide and/or copper hydroxide being preferred. Metal oxides are also suitable, nickel oxide, silver oxide, cobalt oxide and/or copper oxide being preferred. It is also possible to use mixtures of metal oxides and metal hydroxides of the same or different metals.

From the group consisting of the metal salts, metal hydroxides and the metal oxides, the metal salts which are not hydroxides or oxides are preferred.

Polyetherpolyols, such as, for example, (poly)alkylene oxides, can be used as polyols. Polyetherpolyols which can be prepared from styrene oxide, ethylene oxide, propylene oxide, butylene oxide and/or tetrahydrofuran in a known manner by corresponding polymerization processes may be mentioned by way of example. It is also possible to use corresponding monomer mixtures. Polyethylene glycol and in particular polypropylene glycol are preferred. It is also possible to use alkyl(poly)alkylene oxides, it being possible for alkyl to be a branched or straight-chain C-1 to C-20 alkyl radical. In the case of the alkyl(poly)alkylene oxides, methyl(poly)alkylene oxides are particularly preferred.

In contrast to polyesterpolyols, polyetherpolyols have no ester groups or acid groups.

Also suitable for carrying out the invention are polyesterpolyols, such as, for example, polycondensates of dicarboxylic acids or tricarboxylic acids, for example citric acid, tartaric acid, sebacic acid, malic acid and/or succinic acid, glutaric acid, undecanedioic acid, dodecanedioic acid, terephthalic acid and/or isophthalic acid, with hydroxy compounds which have at least two hydroxyl groups suitable for ester formation. Suitable, preferably low molecular weight hydroxy compounds are diols, triols, or polyols. Diols are preferred. Ethylene glycol, propylene glycol, diethylene glycol, triethylene glycol, dipropylene glycol, 1,4-butanediol, 1,6-hexanediol, 1,8-octanediol, 1,10-decanediol, 1,12-dodecanediol, dimeric fatty alcohol, glycerol, pentaerythritol and/or trimethylolpropane may be mentioned by way of example.

Polyetherpolyols are preferred compared with the polyesterpolyols. Also suitable are polycaprolactonepolyols, preferably polycaprolactonediols and also polycarbonatepolyols, particularly preferably polycarbonatediols.

A further group of polyols which can preferably be used comprises the oleochemical polyols. Oleochemical polyols are understood as meaning polyols based on natural fats and oils, for example the reaction products of epoxidized fats with mono-, di- or polyfunctional alcohols or glyceryl esters of long-chain fatty acids, which are at least partly substituted by hydroxyl groups.

A subgroup of these compounds comprises the ring-opening products of epoxidized triglycerides, i.e. epoxidized fatty acid glyceryl esters, in which the ring opening has been carried out with production of the ester bonds. For the preparation of the ring-opening products, it is possible to start from a multiplicity of epoxidized triglycerides of vegetable or animal origin. Thus, for example, epoxidized triglycerides which preferably have 2 to 10 percent by weight of epoxide oxygen are suitable. Such products can be prepared by epoxidation of the double bonds of a series of fats and oils, e.g. beef tallow, palm oil, peanut oil, colza oil, cotton seed oil, soya oil, sunflower oil and linseed oil. Particularly preferred epoxidized triglycerides are epoxidized soya oil and epoxidized linseed oil.

It has been found that particularly small metal nanoparticles can surprisingly be obtained with the use of the relatively high molecular weight polyols according to the invention. For the preparation of the metal nanoparticles, in particular in order to obtain small particle sizes, it is advantageous to work in relatively great dilution, i.e. preferably with an excess of polyol. This excess of polyol can be readily used in a synergistic manner as a raw material in polyurethane chemistry and waste products can be avoided. Because their molecular weight is not too low, the polyols according to the invention are also suitable for further processing in PU systems, in particular in polyurethane-based sealants and adhesives.

The abovementioned metal compounds are preferably dissolved or suspended in polyol or in polyol/water mixtures and this starting material solution or suspension is applied to the rotating body, preferably the rotating reactor disc. The application is preferably effected continuously; it is particularly preferable to use solutions.

Regarding the metal salts described above, particularly preferred ones are those which are relatively readily soluble in polyol or in polyol/water mixtures. The solubility in said solvents should preferably be greater than 10 g/l, particularly preferably greater than 50 g/l and especially preferably greater than 200 g/l.

It is possible to prepare the metal nanoparticles both in mixed form and in pure form. With the use of different metals, both alloys and mixtures of the corresponding metal nanoparticles can form. In the preparation of mixed metal nanoparticles or of the alloys, a mixture of abovementioned metal compounds to be reduced is accordingly used in the desired composition. The mixed metal nanoparticles or alloys are preferably of silver/nickel, silver/copper, silver/cobalt, platinum/copper, ruthenium/platinum and iridium/platinum. Metal nanoparticles or alloys of silver/copper are particularly preferred.

In a particular embodiment of the invention, the metal nanoparticles are copper particles and/or silver particles. Metal nanoparticles of copper and/or silver, which were prepared from copper(II) acetate, copper(II) nitrate, copper(II) sulphate, copper(II) chloride, copper(II) formate and/or Fehling's solution II, silver nitrate, silver acetate, silver formate and/or silver tetrafluoroborate, are particularly preferred. Copper nitrate, copper acetate, silver nitrate and/or silver acetate are particularly preferred.

In a further preferred embodiment of the invention, the metal salts are nitrates and/or acetates. These salts can be readily reduced and their generally good solubility in the polyols or polyol/water mixtures is particularly advantageous.

In a preferred embodiment, polyols whose molecular weight is from 4000 to 12 000 Da are used. As already mentioned above, particularly small particle sizes can be realized with relatively high molecular weights of the polyols.

The process can also be carried out particularly advantageously with poly(alkylene oxides). Poly(alkylene oxides) have good resistance to thermal loads compared with other polyols, such as, for example, polyesterpolyols.

Poly(alkylene oxides) which are distinguished in that the proportion of C-3 to C-12 alkylene oxides in the poly(alkylene oxide) is greater than 20% by weight, preferably greater than 50% by weight, particularly preferably greater than 80% by weight, may be mentioned as a particularly advantageous embodiment. The selection of C.3 alkylene oxide (propylene glycol) from the group of C.3 to C.12 alkylene oxides is particularly preferred. Block polymers are particularly preferred. Relatively hydrophobic polyols are advantageous since they are sparingly soluble in water. Thus, it is possible to establish relatively hydrophobic properties of the polyurethane-based sealants and adhesives. The resistance thereof to the action of water is increased thereby.

In the process according to the invention, polyesterpolyols can preferably be used. These can also be used as hotmelt adhesives.

In a further preferred embodiment of the invention, the rotational speed of the rotating body or the reactor disc is 200 to 3000 revolutions per minute, preferably 300 to 1000 revolutions per minute. An advantage of the relatively high rotational speeds is that the average residence time on the surface of the rotating body can be made relatively short in order as far as possible to minimize possible decomposition processes.

In a preferred embodiment of the invention, the preparation of the metal nanoparticles is carried out at a temperature of 140 to 220° C., particularly preferably of 160 to 200° C. At the relatively high temperatures, the residence time on the rotating body or the rotating reactor disc can be made particularly short (for example by the rotational speed), without the conversion rate being adversely affected. Particularly in the case of sensitive raw materials, this is advantageous for avoiding a decomposition reaction, such as, for example, in the case of some polyesterpolyols.

At the high temperatures on the SDR disc, it is to be expected that the water will for the most part be removed from the polyols. By applying a vacuum or flushing with air or nitrogen, it is possible to enhance this effect.

In a further embodiment, the process according to the invention is characterized in that the reduction of the metal salts is preferably effected in the absence of reducing agents which do not correspond to a polyol according to the invention.

In a further preferred embodiment of the invention, the reduction of the metal salts is effected in the absence of stabilizers, preferably in the absence of polymeric stabilizers. Stabilizers may be, for example, starch, polyvinylpyrrolidone or other preferably polymeric additives which may help to prevent the formation of relatively large metal nanoparticles.

An embodiment of the invention is characterized in that a solution or suspension of a metal salt, metal hydroxide and/or a metal oxide in the polyol or in a polyol/water mixture is applied, preferably continuously, to the rotating body, preferably the rotating reactor disc. Metering is preferably effected centrally, based on a circular reactor disc. Metal salts are preferred compared with the metal hydroxides and metal oxides. Metal hydroxides and metal oxides generally have relatively poor solubility.

In a preferred embodiment of the invention, ionic liquids and/or dipolar aprotic solvents may be present in the polyol or in the polyol/water mixture as solubilizers for increasing the solubility of the compounds (metal salts) to be reduced to metal nanoparticles. For example, dimethyl sulphoxide and/or dimethylformamide are suitable. Ionic liquids are generally defined as salts which melt at low temperatures (<100° C.) and represent a novel class of liquids having a nonmolecular, ionic character. In contrast to classical salt melts which constitute high-melting, highly viscous and very corrosive media, ionic liquids are liquid and have a relatively low viscosity even at low temperatures (K. R. Seddon, J. Chem. Technol. Biotechnol. 1997, 68, 351-356).

Suitable ionic liquids are preferably the quaternary nitrogen and/or phosphorus compounds mentioned in WO2007/115750. Peralkylated guanidinium salts are preferred. The person skilled in the art deduces the ratios of these additives required for increasing the solubility in the course of his usual experimental routine.

In a particularly preferred embodiment of the invention, the surface of the rotating body, preferably of the reactor disc and hence of the reaction mixture, is irradiated with UV light. Particularly in the case of silver nitrate and in the case of mixtures of silver nitrate with soluble copper salts, additional irradiation with UV light is advantageous for increasing the yield.

With the process according to the invention, a rational (few process steps and continuous process) and cheap method (few and cheap raw materials) for the preparation of metal nanoparticles was developed. The products obtained are suitable for direct further processing in polyurethane products, in particular in polyurethane-based sealants and adhesives. The metal nanoparticles themselves meet the requirements with regard to their size distribution.

Experimental description for the preparation of metal nanoparticles by means of the SDR process.

An appropriate amount of metal salt is dissolved or suspended in demineralized water (cf. Table 1). The solution obtained is then mixed into the corresponding polyol (1000 g) with stirring. This mixture is metered with a certain flow rate (in general about 4 ml/s) preferably centrally onto the thermostated (preferably about 200° C.) disc, the speed of the disc being appropriately adjusted (preferably 200, 400 or 800 rpm). Polypropylene glycol (PPG) of corresponding molar masses was used as the polyol. According to these general instructions, the samples E-1 (light brown), E-2 (dark brown) and C-1 (yellowish) of Table 1 were prepared by means of the SDR process.

### BATCH PROCESS (COMPARATIVE EXAMPLE C-2)

1 g of silver nitrate is dissolved in 2 g of demineralized water and then mixed into 1000 g of polypropylene glycol (8000 Da). This mixture is stirred at a temperature of 25° C. for two hours 20 min. At the temperature of 25° C., no conversion or no reduction of silver nitrate to silver was found.

Analysis

The analysis of the samples emerging from the SDR apparatus was effected in each case by means of UV-VIS spectroscopy, dynamic light scattering (DLS) and transmission electron microscopy (TEM).

The determination of the particle size by means of dynamic light scattering (DLS) was effected by means of the StabiSizer®—Nanotrac® ULTRA apparatus (measuring range from 0.8 mm to 6.5 μm). In order to obtain measurable samples, in each case 2.8 g of the samples emerging from the SDR apparatus were diluted in 20 ml of isopropanol. The dilution serves mainly for reducing the viscosity. The results are reproduced in Table 1.

In the case of the transmission electron microscopy (TEM), the metal nanoparticle samples to be analysed were dispersed by means of ethanol between glass microscope slides and prepared on a customary TEM grid. The analysis of the particle size was then effected with the CM120 measuring apparatus Philips (FEI) at an acceleration voltage of 120 kV.

TABLE 1

| | | | Experimental | | Particle |
|---|---|---|---|---|---|
| | | | Parameters | | size |
| | | Dissolve | T_{disc} = 200° C.; | | (nm); |
| Ex. | Metal salt | in | V/s = 4 ml/s | Polyol | DLS |
| E-1 | 10 g AgNO₃ | 5 g H₂O | Speed 400 rpm | PPG 8000 | 50-80 |
| E-2 | 10 g AgNO₃ | 5 g H₂O | Speed 800 rpm | PPG 12 000 | 15-30 |
| C-1 | 10 g AgNO₃ | 5 g H₂O | Speed 200 rpm | PPG 400 | 400-500 |
| | 1 g AgNO₃ | 2 g H₂O | Batch process | PPG 8000 | |
| C-2 | | | (180° C., 2 h | | >1000 |
| | | | reaction time) | | |

The particle size of the samples of Table 1 shows a substantial dependence on the molecular weight of the polypropylene glycols used. With the use of PPG 8000 (E-1) and to an even greater extent in the case of PPG 12 000 (E-2), very small particle sizes are obtained, as desired. Comparative example C-1 with PPG 400 on the other hand gave only very large silver particles (400-500 nm). In comparative example C-2 (batch process), only very coarse particles were observed (with the eye), a high proportion being present in a particle size substantially greater than 1 mm. It was possible to show that, with the spinning-disc method and with the use of polyols having a high molecular weight, very small nanoparticles can be obtained. In contrast, batch processes and the use of low molecular weight polyols lead to an unsatisfactory result. The results of the DLS measurements with regard to the particle size were completely confirmed in their trend by the transmission electron micrographs (TEM) (particle size E-2<E-1<C-1).

Furthermore, the relative conversion of the reduction reaction to silver for the three samples E-1, E-2 and C-1 was determined approximately by DLS measurements. The conversion of sample C-1 is standardized to 1. The relative conversion of E-1 is about a factor of 6 greater and in the case of E-2 the relative conversion is about a factor of 26 greater. The use of high molecular weight polyols according to the invention consequently also has the additional advantage that relatively high conversions can be achieved.

1. Process for the preparation of metal nanoparticles, selected from the group consisting of lead, bismuth, zinc, antimony, indium, gold, nickel, cobalt, palladium, platinum, iridium, osmium, rhodium, ruthenium, rhenium, vanadium, chromium, manganese, niobium, molybdenum, tungsten, tantalum, cadmium, silver, copper or mixtures thereof, on a rotating body, wherein a reduction of corresponding metal salts, corresponding metal salt complexes, corresponding metal hydroxides and/or corresponding metal oxides by polyols having a number of hydroxyl groups in the polyol of 1 to 10 and a molecular weight of the polyols of 2000 to 18 000 Da is effected.

2. Process according to claim 1, wherein the metal nanoparticles are copper particles and/or silver particles.

3. Process according to claim 1, wherein the metal salts used are nitrates and/or acetates.

4. Process according to claim 1, wherein the molecular weight of the polyols is 4000 to 12 000 Da.

5. Process according to claim 1, wherein the polyols are poly(alkylene oxides).

6. Process according to claim 5, wherein a proportion of C-3 to C-12 alkylene oxides in the poly(alkylene oxide) is greater than 20 percent by weight.

7. Process according to claim 1, wherein the polyols are polyesterpolyols.

8. Process according to claim 1, wherein the rotational speed of the rotating body is 200 to 3000 revolutions per minute.

9. Process according to claim 1, wherein the preparation of the metal nanoparticles is carried out at a temperature of 140 to 220° C.

10. Process according to claim 1, wherein the reduction of the metal salts is effected in the absence of reducing agents which do not correspond to the polyol.

11. Process according to claim 1, wherein the reduction of the metal salts is effected in the absence of stabilizers.

12. Process according to claim 1, wherein a solution or suspension of a metal salt, metal salt complex, metal hydroxide and/or a metal oxide in the polyol or in a mixture of the polyol and water is metered onto the rotating body.

13. Process according to claim 1, wherein ionic liquids and/or dipolar aprotic solvents are present as solubilizers in the polyol or in the polyol/water mixture.

14. Process according to claim 1, wherein irradiation of the surface of the rotating body with UV light is effected.
